(19) United States
(12) Patent Application Publication
(10) Pub. No.: US 2006/0265934 A1
(43) Pub. Date: Nov. 30, 2006

(54) Pole holder

(76) Inventor: Alan Morris, Hamden, CT (US)

Correspondence Address: O'SHEA, GETZ & KOSAKOWSKI, P.C., 1500 MAIN ST., SUITE 912, SPRINGFIELD, MA, 01115, US

(21) Appl. No.: 11/441,626

(22) Filed: May 26, 2006

Related U.S. Application Data
(60) Provisional application No. 60/684,836, filed on May 26, 2005.

(51) Int. Cl. A01K 97/10

(52) U.S. Cl. 43/21.2

(57) ABSTRACT

A pole holder is provided that includes a shell, a stem, and a pivot joint. In one embodiment, the holder includes a clamp that enables the holder to be attached to a variety of structures. In another embodiment, the holder includes an auger that allows the holder to be secured within a solid medium such as ice.

This application claims the benefit of U.S. Provisional Patent Application Ser. No. 60/684,836 filed on May 26, 2005.

### BACKGROUND OF THE INVENTION

1. Technical Field

This invention relates to pole holders in general, and to pivotable fishing pole holders in particular.

2. Background Information

Sport fishing catalogs and showrooms are replete with fishing pole holders that may be fastened to boats or other structures such as railings and pilings in a permanent fashion. None of these however, serve the need of a day fisherman who visits one or more docks. Such activity requires an easily mounted and dismounted portable fishing pole holder; particularly one that will not harm the surface it is attached to and one which may be readily used with many common features found at many fishing sites or boats that do not offer rod holders (i.e., canoes, kayaks, small boats, etc.).

### DISCLOSURE OF INVENTION

According to the present invention a pole holder is provided that includes a shell, a stem and a pivot joint. The shell includes a cavity for receiving a pole. The stem extends between the shell and the pivot joint. In one embodiment, the pole holder further includes a clamp having a first jaw member, a second jaw member, and a tightening mechanism operable to fix an object between the first and second jaw members. The clamp and pivot member are connected to one another. In another embodiment, the holder includes an auger connected to the pivot joint.

Advantages of the present invention include, but are not limited to, a portable pole holder that can be easily mounted on any solid surface whether round or flat, and which holder can be dismounted and placed at another location with the ease, leaving no marks of damage to the structure on which it was placed. Additionally, the present invention pole holder allows the angular orientation of the pole to be easily adjusted relative to the clamp or auger.

Other objects and features and advantages of the present invention will become more apparent in the light of the following detailed description of exemplary embodiments thereof, as illustrated in the accompanying drawings.

### BRIEF DESCRIPTION OF DRAWINGS

FIG. 1 is a partially sectioned side elevation view of the invention as an exploded view.

FIG. 2 is another side view of the invention as it would be affixed to a wood structure.

FIG. 3 is a view of the clamp mechanism showing that the upper arm connected to the tube is fully adjustable to 360 degrees and also that the arm is able to move up and down the shaft to allow greater mobility.

FIG. 4 is a diagrammatic view of a pivot joint.

FIG. 5 is a perspective view of an embodiment of the present invention holder.

### BEST MODE FOR CARRYING OUT THE INVENTION

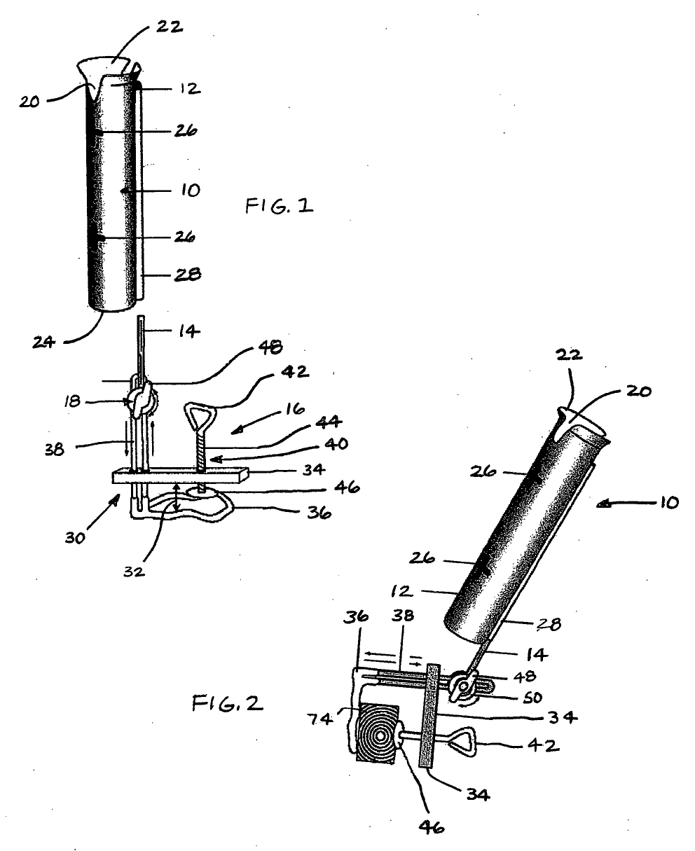

Referring now to FIGS. 1-3, a fishing pole holder 10 includes a shell 12, a stem 14, a clamp 16, and a pivot joint 18. The shell 12, which can be made of any suitable material, may be formed in one or more pieces. The shell 12 has a cavity 20 for receiving the handle of a fishing pole. In some embodiments, the shell 12 includes a flaired opening 22 at one end to facilitate inserting the pole into the cavity 20. The end 24 of the shell 12 opposite the flaired opening 22 may be completely closed, partially closed, or open. A partially closed end 24 prevents the pole from traveling through the shell 12, but allows liquid to drain out of the shell 12. The shell 12 can also include features that facilitate hanging the holder 10 on a wall or other surface. For example, apertures 26 disposed within the shell 12 can receive a hook or other appendage to permit the shell 12 to be hung on a wall or other surface. The apertures 26 are shown in the form of a cross, but can be made as any shape to permit the shell 12 to be vertically or horizontally hung.

The shell 12 includes a feature for attaching the stem 14 to the shell 12. In the embodiment shown in FIGS. 1 and 2, for example, the shell 12 includes a feature in the form of a chamber 28 attached to shell 12. The chamber 28 includes a cavity for receiving the stem 14. The chamber 28 can be incorporated integrally with the shell 12, or be affixed in any suitable manner. The chamber 28 represents only one embodiment of a feature for attaching the stem 14 to the shell 12. Alternative feature embodiments include, but are not limited to, clamps, clips, and mechanical fasteners.

The stem 14 is connected to the pivot joint 18, which is in turn connected to the clamp 16. The stem 14 can be made of any suitable material; e.g., a rigid and stable material such as No. 304 marine stainless steel is an acceptable material. The stem 14 is received within the chamber 28 and thereby attached to the shell 12. The stem 14 may be permanently or selectively attached to the shell 12. The stem 14 may be swiveled up to 360 degrees.

The clamp 16 is operable to securely fix the holder 10 to an object. The clamp 16 may be configured in a variety of different geometries to permit attachment to a variety of different object shapes. In preferred embodiments, the clamp 16 includes a mechanism 30 for gross adjustment of the size of the opening 32 of the clamp 16, and a tightening mechanism to secure an object within the clamp 16. The opening 32 of the clamp 16 is the dimension through which an object that can be inserted into the clamp 16 and be secured.

In the embodiment shown in FIGS. 1 and 2, the clamp 16 includes a first jaw portion 34, a second jaw portion 36, a bracket 38, and a tightening mechanism 40 attached to one of the jaw portions 34, 36. One or both of the jaw portions 34, 36 can be partially of completely covered with a material (e.g., high density rubber) to help prevent forming marks on the object being clamped. The bracket 38 extends between the jaw portions 34, 36. One or both of the jaw portions 34, 36 can be slid ably attached to the bracket 38 to facilitate gross adjustment of the clamp 16. The size of the clamp 16 can be varied to suit a variety of applications. For example, in most dock or boat applications a clamp 16 sized to receive an object having a width between one-half inch and five and one-half inches is adequate.

The tightening mechanism 40 is operable to fix the object within the clamp 16, between the jaw portions 34, 36. In the embodiment shown in FIGS. 1 and 2, the tightening mechanism 40 includes a thumb screw 42 with a threaded portion 44 that is in threaded engagement with the first jaw portion 34. A swivel round 46 is attached to one end of the thumb screw 42. The swivel round 46 can be partially or completely covered with a material (e.g., high density rubber) to help prevent forming marks on the object being clamped. Alternative tightening mechanisms 40 other than that shown in FIGS. 1 and 2 can be used. For example, a lever with a cam element that can be manipulated to bias one of the jaw portions 34, 36 toward the other jaw portion 36, 34 can be used. The lever is positionable in a first position where no force is applied to the jaw portion, and a second position where force is maintained on the jaw portion.

Referring to FIGS. 1-5, the pivot joint 18 is operable to change the angular orientation of the shell 12 relative to the clamp 16, and consequently the angular orientation of the shell 12 relative to the object clamped. The pivot joint 18 may have a predefined number of positions that can be assumed (e.g., a predetermined position every 10° of pivot), or an infinite number of positions.

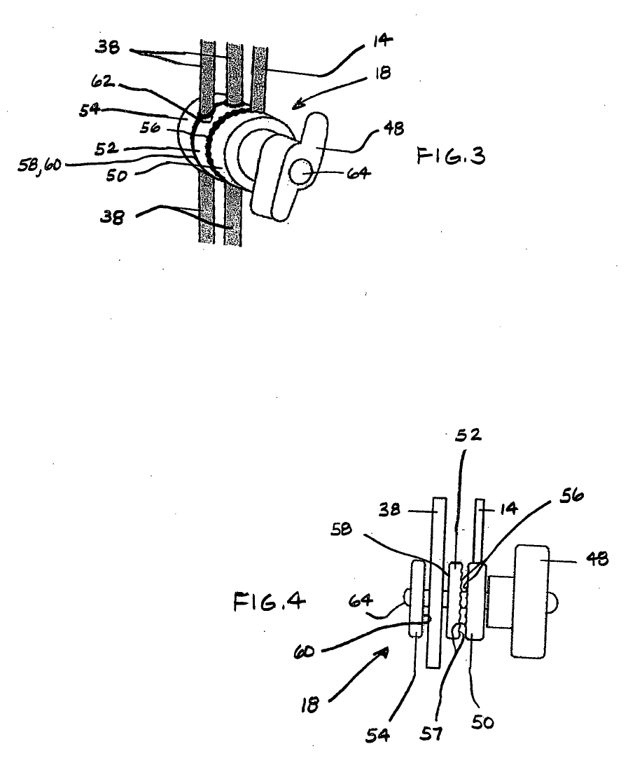

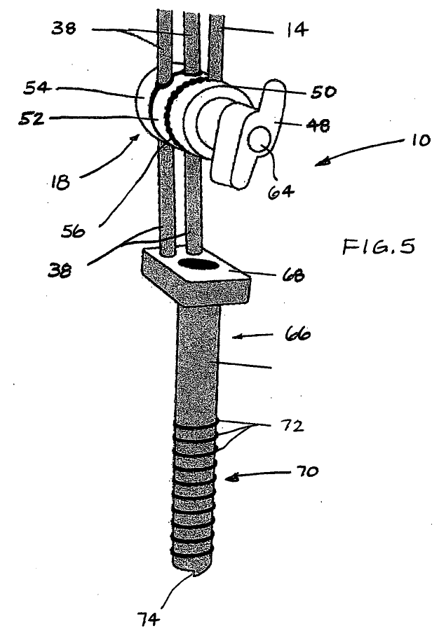

The pivot joint 18 embodiment shown in FIGS. 3 and 4 includes a thumbwheel 48, a first joint member 50, a second joint member 52, and a third joint member 54. The pivot joint 18 is shown as round-shaped, but is not limited to a round shape. The first joint member 50 is attached to stem 14 (e.g., by welding). The first joint member 50 and second joint member 52 each have a contact surface 56 oriented to face one another. The contact surfaces 56 are configured such that bringing the surfaces 56 together will inhibit relative rotation of the first and second joint members 50, 52. In some embodiments, the contact surfaces 56 may have “n” number of mating male and female features. The features mate together to inhibit relative motion, and provide “n” number of predetermined pivotal positions. The embodiment shown in FIGS. 3 and 4, for example, has contact surfaces 56 that have machined ridges or teeth 57 that mate with one another that inhibit relative motion between the first and second joint members 50, 52.

In the embodiment shown in FIG. 3, the surface 58 of the second joint member 52 (opposite the contact surface 56) and a surface 60 of the third joint member 54 each includes a pair of notches 62 to receive the bracket 38 portion of the clamp 16. A fastener 64 (e.g., a bolt) extends through apertures in the first, second, and third joint members 50, 52, 54 for threadable engagement with the thumbwheel 48. Alternatively, the fastener 64 may be fixed to the third joint member 54. When the thumbwheel 48 is tightened, the contact surfaces 56 of the first and second joint members 50, 52 engage one another, and the notched surfaces 62 of the second and third joint members 52, 54 are drawn toward one another. As a result, the first and second joint members 50, 52 will not rotate relative to one another during use, and the bracket 38 becomes clamped, thereby fixing the pivot joint 18 relative to the bracket 38. The pivot joint 18 described above represents an example of an acceptable pivot joint. The present invention is not limited to this embodiment, however.

As an example of how the holder 10 can be utilized, the user can adjust the clamp 16 by sliding the first jaw member 34 along the bracket 38 until the object to which the holder 10 is to be clamped can be received within the clamp 16. The object can then be secured fixed within the clamp 16 by actuating the tightening mechanism 40; e.g., rotating the thumb screw 42 until the swivel round 46 is forced against the object. FIG. 2, for example, illustrates a wooden board 76 disposed within the clamp 16. In those embodiments where the stem 14 is not fixedly attached to the shell 12, the shell 12 can be selectively attached to the stem 14. The angle of the shell 12, and the position of the shell 12 relative to the clamp 16 (and therefore the angle and position of the pole relative to the clamp 16), can be adjusted to a desirable angle by loosening the pivot joint 18. To adjust the position relative to the clamp 16, the pivot joint 18 is laterally moved along the bracket. To adjust the angle, the first joint member 50 and attached stem 14/shell 12 are pivoted to the desired orientation. Once the desired position and orientation are secured, the pivot joint 18 is tightened by rotating the thumbwheel 48.

Referring now to FIG. 5, in an alternative embodiment the holder 10 includes an auger shaft 66 in place of clamp 16. A shaft bracket 68 connects the auger shaft 66 to the bracket 38 that extends up to the pivot joint 18. The shaft bracket 68 may be configured (e.g., shaped like a nut) to facilitate rotation of the shaft 22, and is sized to provide sufficient structural support for pivot joint 18 and attached shell 12. The shaft bracket 68 may be made of a variety of materials including, but not limited to, No. 304 stainless steel. Bracket 38 can be attached to bracket 68 permanently (e.g., by weld) or selectively (e.g., by clamp).

The auger shaft 66 includes a screw portion 70. The dimensions of the screw portion 70 can be varied to suit the application at hand. An acceptable screw portion 70 operable to secure the holder 10 to a body of ice, for example, may be approximately four and one-half inches in length and five-eighths of an inch in diameter with a one-eighth inch thick sidewall. The auger screw 70 may be hollow to allow ice to pass through its center cavity, or may be solid. The threads 72 of the screw portion 70 enable the auger to be easily be screwed into any ice surface and conversely screwed out when done. The screw portion 70 may also have teeth 74 disposed on the bottom of the screw portion 70 to facilitate penetration of the auger 66 into the ice surface.

Since many changes and variations of the disclosed embodiment of the invention may be made without departing from the inventive concept, it is not intended to limit the invention otherwise than as required by the appended claims.

What is claimed is:

1. A pole holder, comprising:
a shell having a cavity for receiving a pole;
a clamp having a first jaw member, a second jaw member, an opening that extends between the first and second jaw members, and a tightening mechanism operable to fix an object between the first and second jaw members;
a pivot joint connected to the clamp;
a stem extending between the shell and the pivot joint, wherein stem is pivotally mounted relative to the clamp and operable to selectively change the angular orientation between the clamp and the shell.

2. The holder of claim 1, wherein the shell comprises a feature for attaching the stem to the shell.

3. The holder of claim 2, wherein the feature includes a chamber attached to the shell.

4. The holder of claim 1, wherein the stem is operable to be rotated 360°.

5. The holder of claim 1, wherein the clamp comprises mechanism for gross adjustment of the size of the opening of the clamp.

6. The holder of claim 5, wherein the mechanism for gross adjustment of the size of the opening of the clamp comprises a bracket extending between the first and second jaw members, and wherein the bracket is slidably mounted relative to at least one of the first and second jaw members.

7. The holder of claim 1, wherein the tightening mechanism comprises a thumb screw threadably engaged with one of the first and second jaw members, and a swivel round.

8. The holder of claim 1, wherein the pivot joint comprises a first joint member having a first contact surface and a second joint member having a second contact surface;
wherein the first contact surface and the second contact surfaces face one another and having mating geometries to inhibit relative motion between the first and second joint members; and
wherein the stem is attached to the first joint member.

9. The holder of claim 8, wherein a fastener extends through apertures disposed within the first and second joint members, and wherein the fastener is operable to secure the first and second joint members together.

10. The holder of claim 9, wherein the pivot joint further comprises a third joint member, and the second joint member is disposed between the first and third joint members.

11. The holder of claim 10, wherein the fastener extends through apertures disposed within the first, second, and third joint members, and wherein the fastener is operable to secure the first, second, and third joint members together.

12. The holder of claim 10, wherein the fastener is fixed to the third joint member and is operable to secure the first, second, and third joint members together.

13. A pole holder, comprising:
a shell having a cavity for receiving a pole;
a pivot joint;
an auger connected to the pivot joint;
a stem extending between the shell and the pivot joint, wherein stem is pivotally mounted relative to the auger and operable to selectively change the angular orientation between the auger and the shell.

14. The holder of claim 13, wherein the shell comprises a feature for attaching the stem to the shell.

15. The holder of claim 13, wherein the feature includes a chamber attached to the shell.

16. The holder of claim 13, wherein the stem is operable to be rotated 360°.

17. The holder of claim 13, wherein the pivot joint comprises a first joint member having a first contact surface and a second joint member having a second contact surface;
wherein the first contact surface and the second contact surfaces face one another and having mating geometries to inhibit relative motion between the first and second joint members; and
wherein the stem is attached to the first joint member.

18. The holder of claim 17, wherein a fastener extends through apertures disposed within the first and second joint members, and wherein the fastener is operable to secure the first and second joint members together.

19. The holder of claim 18, wherein the pivot joint further comprises a third joint member, and the second joint member is disposed between the first and third joint members.

20. The holder of claim 19, wherein the fastener extends through apertures disposed within the first, second, and third joint members, and wherein the fastener is operable to secure the first, second, and third joint members together.

21. The holder of claim 19, wherein the fastener is fixed to the third joint member and is operable to secure the first, second, and third joint members together.
